(19) United States
(12) Patent Application Publication
(10) Pub. No.: US 2018/0144681 A1
(43) Pub. Date: May 24, 2018

(54) DRIVE METHOD AND DRIVE DEVICE FOR A DISPLAY PANEL, DISPLAY PANEL, AND DISPLAY DEVICE

(71) Applicant: SHANGHAI TIANMA AM-OLED CO., LTD., Shanghai (CN)

(72) Inventors: Dongxu Xiang, Shanghai (CN); Yue Li, Shanghai (CN); Zeyuan Chen, Shanghai (CN); Renyuan Zhu, Shanghai (CN); Yana Gao, Shanghai (CN); Zhonglan Cai, Shanghai (CN)

(73) Assignee: SHANGHAI TIANMA AM-OLED CO., LTD., Shanghai (CN)

(21) Appl. No.: 15/862,584

(22) Filed: Jan. 4, 2018

(30) Foreign Application Priority Data
Aug. 17, 2017 (CN) 201710707987.4

(51) Int. Cl. G09G 3/20

(52) U.S. Cl. CPC G09G 3/2092; G09G 2340/0414; G09G 2320/0247; G09G 2330/021

(57) ABSTRACT

Disclosed are a drive method and a drive device for a display panel, a display panel and a display device. The method comprises: acquiring a picture to be displayed by a display panel; driving the display panel with a first picture refresh frequency to display the picture to be displayed if the number of successive frames of pictures same to the picture to be displayed exceeds a preset number; otherwise, driving the display panel with a second picture refresh frequency to display the picture to be displayed; and, the first picture refresh frequency is less than the second picture refresh frequency.

### CROSS-REFERENCE TO RELATED APPLICATIONS

This application claims priority to Chinese Patent Application No. 201710707987.4, filed on Aug. 17, 2017 and entitled “DRIVE METHOD AND DRIVE DEVICE FOR A DISPLAY PANEL, DISPLAY PANEL, AND DISPLAY DEVICE”, the disclosure of which is incorporated herein by reference in its entirety.

### TECHNICAL FIELD

The present disclosure relates to display technologies, and in particular, to a drive method and a drive device for a display panel, a display panel and a display device.

### BACKGROUND

With the development of display technologies, the display effect of display products has been improved continuously, so that the display products are widely used.

In the prior art, a display panel usually employs a fixed picture refresh frequency to update the picture displayed by the display panel. Even if the display panel is in a stand-by state or displays a static picture for a long time, the display panel still employs the same picture refresh frequency to update the picture. The continuous refreshes for the same display picture may consume a significant amount of power. Therefore, the power consumption of the display panel will be high.

### SUMMARY

The present disclosure provides a drive method and a drive device for a display panel, a display panel and a display device, thereby lowering the power consumption of the display panel.

In a first aspect, embodiments of the disclosure provide a drive method for a display panel, which comprises the steps as follows: a step of acquiring a picture to be displayed by a display panel; a step of driving the display panel with a first picture refresh frequency to display the picture to be displayed if the number of successive frames of pictures same to the picture to be displayed exceeds a preset number of frames; otherwise, driving the display panel with a second picture refresh frequency to display the picture to be displayed. The first picture refresh frequency is less than the second picture refresh frequency.

In a second aspect, embodiments of the disclosure further provide a drive device for a display panel, which comprises: a picture-to-be-displayed acquiring unit, configured for acquiring a picture to be displayed by a display panel; and a picture refresh frequency determining unit, configured for: driving the display panel with a first picture refresh frequency to display the picture to be displayed if the number of successive frames of pictures same to the picture to be displayed exceeds a preset number of frames; otherwise, driving the display panel with a second picture refresh frequency to display the picture to be displayed. The first picture refresh frequency is less than the second picture refresh frequency.

In a third aspect, embodiments of the disclosure further provide a display panel, which includes the drive device according to any of embodiments of the disclosure.

In a fourth aspect, embodiments of the disclosure further provide a display device, which includes the display panel according to any of embodiments of the disclosure.

In the embodiments of the disclosure, when the number of successive frames of pictures same to the picture to be displayed by the display panel exceeds a preset number of frames, the display panel may be driven with a small first picture refresh frequency to display the picture to be displayed, so that when the display panel is in a stand-by state or in a state for displaying a static picture for a long time, the display picture does not need to be refreshed with a high frequency, thereby lowering the power consumption of the display panel.

### BRIEF DESCRIPTION OF THE DRAWINGS

FIG. 1 is a flow chart of a drive method for a display panel according to an embodiment of the disclosure;

FIG. 2 is a structural diagram of a pixel drive circuit of a display panel according to an embodiment of the disclosure;

FIG. 3 is a circuit diagram of a pixel drive circuit of a display panel according to an embodiment of the disclosure;

FIG. 4 is a drive timing diagram in which the display panel is driven with a second picture refresh frequency according to an embodiment of the disclosure;

FIG. 5 is a schematic diagram of a display panel according to an embodiment of the disclosure;

FIG. 6 is a drive timing diagram in which the display panel is driven with a first picture refresh frequency according to an embodiment of the disclosure;

FIG. 7 is another drive timing diagram in which the display panel is driven with a first picture refresh frequency according to an embodiment of the disclosure;

FIG. 8 is a schematic diagram of a drive device for a display panel according to an embodiment of the disclosure;

FIG. 9 is a structural representation of a display panel according to an embodiment of the disclosure; and

FIG. 10 is a structural representation of a display device according to an embodiment of the disclosure.

### DETAILED DESCRIPTION

The application will be illustrated in detail in conjunction with the drawings and embodiments. It may be understood that, the embodiments described here are only set for explaining, rather than limiting, the application. Additionally, it further needs to be noted that, for convenient description, the drawings only show the parts related to the application, rather than the whole structure.

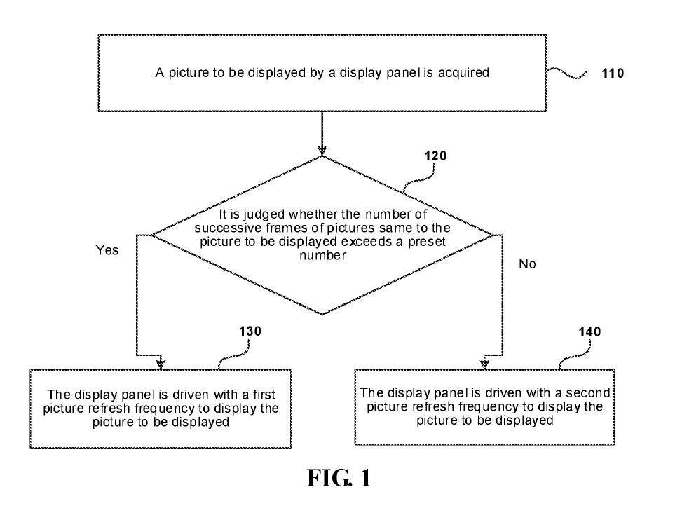

One embodiment of the disclosure provides a drive method for a display panel. FIG. 1 is a flow chart of a drive method for a display panel according to an embodiment of the disclosure. Referring to FIG. 1, the method includes the following steps.

Step 110: A picture to be displayed by a display panel is acquired.

Step 120: It is judged whether the number of successive frames of pictures same to the picture to be displayed exceeds a preset number of frames, if yes, it turns to Step 130; if not, it turns to Step 140.

Step 130: The display panel is driven with a first picture refresh frequency to display the picture to be displayed.

Step 140: The display panel is driven with a second picture refresh frequency to display the picture to be displayed.

The first picture refresh frequency is less than the second picture refresh frequency.

In one embodiment, the picture to be displayed is a picture to be displayed by the display panel. The display panel may acquire in real time the picture to be displayed and judges whether the number of successive frames of pictures same to the picture to be displayed exceeds a preset number of frames. If the number of successive frames of pictures same to the picture to be displayed exceeds the preset number of frames, it indicates that the picture to be displayed is a static picture or the display panel is in a stand-by state, and hence the picture to be displayed by the display panel does not need to be updated with a high frequency, so that the picture to be displayed may be displayed with a low first picture refresh frequency, thereby lowering the power consumption of the display panel. The preset number of frames, the first picture refresh frequency and the second picture refresh frequency may be set as necessary, rather than being specifically defined.

In one embodiment, the second picture refresh frequency may be 60 HZ, and the first picture refresh frequency may be 30 HZ or 20 HZ, etc. When the display panel displays normally, the second picture refresh frequency is employed, for example, 60 HZ, that is, data are written to the display panel for 60 times in one minute, and the picture of the display panel is refreshed for 60 times. When the display panel is in a stand-by state or displays a static picture for a long time, the first picture refresh frequency is employed, for example, 30 HZ, that is, data are written to the display panel for only 30 times in one minute, and the picture of the display panel is refreshed for 30 times, so that the overall power consumption of the display panel may be lowered.

In this embodiment, when the number of successive frames of pictures same to the picture to be displayed by a display panel exceeds a preset number of frames, the display panel may be driven with a small first picture refresh frequency to display the picture to be displayed, so that when the display panel is in a stand-by state or in a state for displaying a static picture for a long time, the display picture does not need to be refreshed with a high frequency, thereby lowering the power consumption of the display panel.

In one embodiment, the preset number of frames is greater than or equal to 10.

In one embodiment, the preset number of frames is greater than or equal to 10, such that on one hand, the case that the display panel frequently switches the picture refresh frequencies due to too small preset number of frames, which is adverse to the operation of the display panel, may be void; on the other hand, it can reasonably judge whether the display panel is in a stand-by state or displays a static picture, so that the picture refresh frequencies can be switched reasonably, thereby lowering the power consumption of the display panel.

In one embodiment, one frame of display picture includes a light-emitting stage, and then driving the display panel with the first picture refresh frequency to display the picture to be displayed includes: in the light-emitting stage of one frame of display picture, a pixel light-emitting control signal controls a light-emitting element of the display panel to be turned off for n times to divide the light-emitting stage into n+1 sub-light-emitting stages, wherein n is a positive integer greater than or equal to 1.

In one embodiment, when the first picture refresh frequency is low, each frame of display picture has a long retention time, and in this case, the switch between the picture to be displayed may be perceived by human eyes, that is, human eyes may feel the picture flicking on the display panel. In the light-emitting stage of one frame of display picture, the light-emitting element is controlled to be turned off for n times via a pixel light-emitting control signal, so that one frame of display picture is interrupted for n times during display, that is, one frame of display picture is “refreshed” for n times visually, so that the switch between the picture cannot be distinguished by human eyes, thus eliminating picture flicking appearing when the picture to be displayed is displayed using a low first picture refresh frequency. Exemplarily, in the light-emitting stage of one frame of display picture, the pixel light-emitting control signal may be set to include n high pulses or n low pulses to control the light-emitting element to be turned off for n times, and other control signals needed to drive the display of the display panel may still employ a low frequency according to the first picture refresh frequency, so that flicking of the display picture can be avoided while the power consumption of the display panel is lowered, thereby improving the picture display quality. Furthermore, n may be determined according to the magnitude of the first picture refresh frequency, and it may not be specifically defined, so long as no flicking appears when the picture of the display panel is switched.

In one embodiment, the durations of the n+1 sub-light-emitting stages are the same.

In one embodiment, the durations of the n+1 sub-light-emitting stages are the same, so that the interval times between n high pulses or n low pulses of the pixel light-emitting control signal are the same, that is, in the light-emitting stage, the pixel light-emitting control signal is a periodic signal, so that the complexity of the circuit for generating the pixel light-emitting control signal can be lowered. Additionally, it may be avoided that the duration of some sub-light-emitting stages is long and picture flicking may still appear when the light-emitting element is turned off and turned on, so that flicking can be further avoided.

In one embodiment, n=3. In one embodiment, one frame of display picture is interrupted for 3 times during display, such that on one hand, flicking of the display picture may be avoided; on the other hand, a low power consumption for the display panel may be guaranteed.

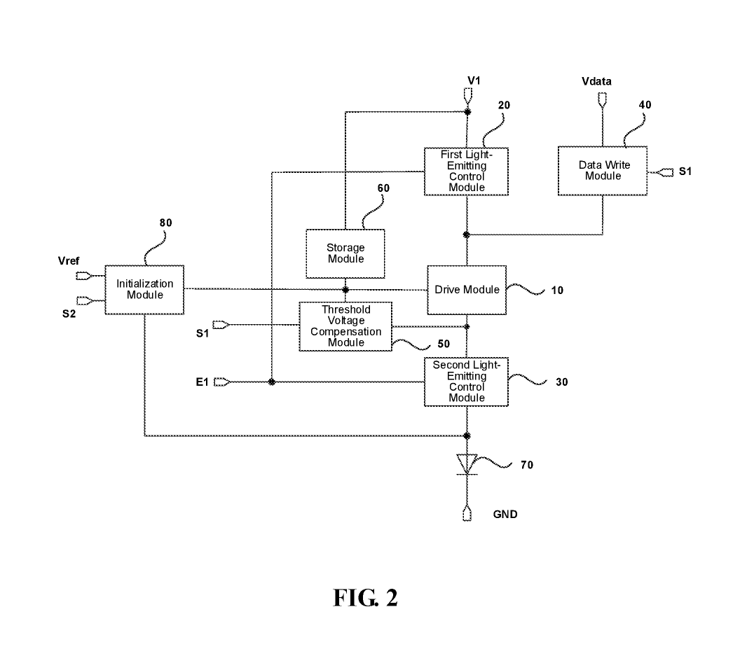

FIG. 2 is a structural diagram of a pixel drive circuit of a display panel according to an embodiment of the disclosure. In one embodiment, referring to FIG. 2, the display panel includes a pixel drive circuit, which is configured for driving the light-emitting element of the display panel 70 to emit light so as to display the picture to be displayed. The pixel drive circuit includes a drive module 10, a first light-emitting control module 20, a second light-emitting control module 30, a data write module 40, a threshold voltage compensation module 50 and a storage module 60; a control terminal of the first light-emitting control module 20 is configured for receiving a pixel light-emitting control signal E1, a first terminal thereof is configured for receiving a first electrical level signal V1, and a second terminal thereof is electrically connected with a first terminal of the drive module 10; a control terminal of the second light-emitting control module 30 is configured for receiving the pixel light-emitting control signal E1, a first terminal thereof is electrically connected with a second terminal of the drive module 10, and a second terminal thereof is electrically connected with a first electrode of the light-emitting element 70; a first terminal of the data write module 40 is configured for receiving a display data signal Vdata, a second terminal thereof is electrically connected with the first terminal of the drive module 10, and a control terminal thereof is configured for receiving a first scanning signal S1; a control terminal of the threshold voltage compensation module 50 is configured for receiving the first scanning signal S1, a first terminal thereof is electrically connected with the second terminal of the drive module 10, and a second terminal thereof is electrically connected with a control terminal of the drive module 10; and a first terminal of the storage module 60 is configured for receiving the first electrical level signal V1, a second terminal thereof is electrically connected with the control terminal of the drive module 10, and the storage module 60 is configured for maintaining a threshold voltage.

In one embodiment, the first scanning signal S1 controls the data write module 40 to acquire the display data signal Vdata and charges the electric potential on the control terminal of the drive module 10 to the threshold voltage of the drive module 10; and the threshold voltage compensation module 50 is configured for compensating the threshold voltage. The pixel light-emitting control signal E1 is configured for controlling the first light-emitting control module 20 and the second light-emitting control module 30 to be turned on so as to input a light-emitting drive signal outputted by the drive module 10 to the light-emitting element 70 in order to turn on the light-emitting element 70; or, the pixel light-emitting control signal E1 is configured for controlling the first light-emitting control module 20 and the second light-emitting control module 30 to be turn off so as to stop inputting the light-emitting drive signal outputted by the drive module 10 to the light-emitting element 70 in order to turn off the light-emitting element 70.

In one embodiment, the pixel drive circuit further includes an initialization module 80, a control terminal of the initialization module 80 is configured for receiving a second scanning signal S2, a input terminal thereof is configured for receiving a reset signal Vref, a first output terminal thereof is electrically connected with the control terminal of the drive module 10, and a second output terminal thereof is electrically connected with the first electrode of the light-emitting element 70.

In one embodiment, the second scanning signal S2 controls the initialization module 80 to reset the electric potential on the control terminal of the drive module 10 and the first electrode of the light-emitting element 70, thereby realizing the initialization of the pixel drive circuit.

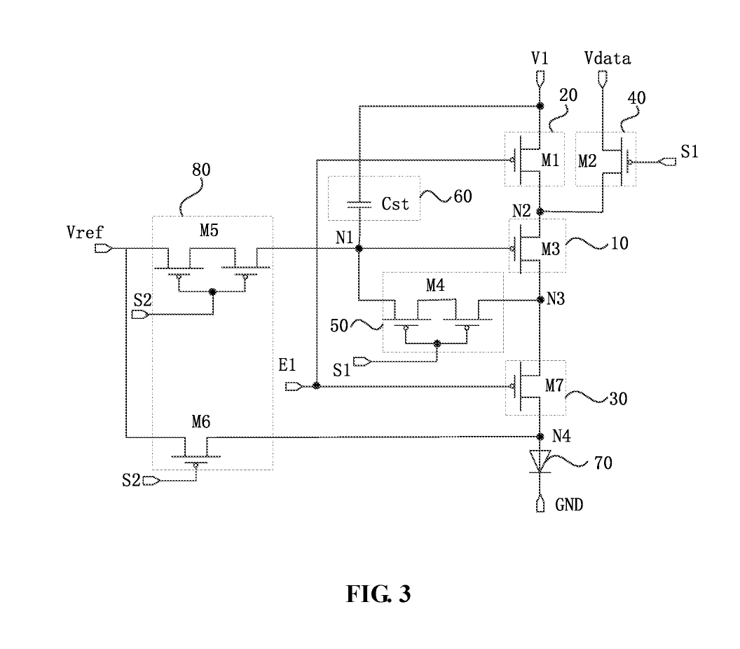

FIG. 3 is a circuit diagram of a pixel drive circuit of a display panel according to an embodiment of the disclosure. Referring to FIG. 3, the drive module 10 includes a third thin-film transistor M3, the first light-emitting control module 20 includes a first thin-film transistor M1, the second light-emitting control module 30 includes a seventh thin-film transistor M7, the data write module 40 includes a second thin-film transistor M2, the threshold voltage compensation module 50 includes a fourth thin-film transistor M4, the storage module 60 includes a capacitor Cst, and the initialization module 80 includes a fifth thin-film transistor M5 and a sixth thin-film transistor M6.

A gate electrode of the first thin-film transistor M1 is configured for receiving a pixel light-emitting control signal E1, a first electrode thereof is configured for receiving a first electrical level signal V1, a second electrode thereof is electrically connected with the first electrode of third thin-film transistor M3. A gate electrode of the second thin-film transistor M2 is configured for receiving a first scanning signal S1, a first electrode thereof is configured for receiving a display data signal Vdata, and a second electrode thereof is electrically connected with a first electrode of third thin-film transistor M3. A gate electrode of the third thin-film transistor M3 is electrically connected with a second electrode of the fifth thin-film transistor M5, and a second electrode thereof is electrically connected with a first electrode of the seventh thin-film transistor M7. A gate electrode of the fourth thin-film transistor M4 is configured for receiving the first scanning signal S1, a first electrode thereof is electrically connected with the gate electrode of the third thin-film transistor M3, and a second electrode thereof is electrically connected with the first electrode of the seventh thin-film transistor M7. A gate electrode of the fifth thin-film transistor M5 is configured for receiving a second scanning signal S2, and the first electrode thereof is configured for receiving a reset signal Vref. A gate electrode of the sixth thin-film transistor M6 is configured for receiving a second scanning signal S2, a first electrode thereof is configured for receiving a reset signal Vref, and a second electrode thereof is electrically connected with the first electrode of the light-emitting element 70. A gate electrode of the seventh thin-film transistor M7 is configured for receiving the pixel light-emitting control signal E1, and a second electrode thereof is electrically connected with the first electrode of the light-emitting element 70.

Referring to FIG. 3, the light-emitting element 70 may be an organic light-emitting diode, and the first electrode of the light-emitting element 70 may be an anode of the organic light-emitting diode. The fourth thin-film transistor M4 and the fifth thin-film transistor M5 may be two thin-film transistors connected in series so as to lower the leakage current. The first thin-film transistor M1, the second thin-film transistor M2, the third thin-film transistor M3, the fourth thin-film transistor M4, the fifth thin-film transistor M5, the sixth thin-film transistor M6 and the seventh thin-film transistor M7 may be N-type thin-film transistors or P-type thin-film transistors. In this embodiment, illustration is given by an example in which the first thin-film transistor M1, the second thin-film transistor M2, the third thin-film transistor M3, the fourth thin-film transistor M4, the fifth thin-film transistor M5, the sixth thin-film transistor M6 and the seventh thin-film transistor M7 are all P-type thin-film transistor.

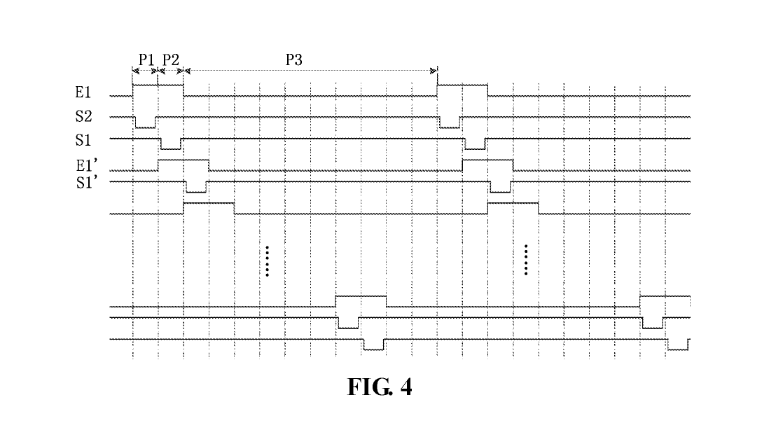

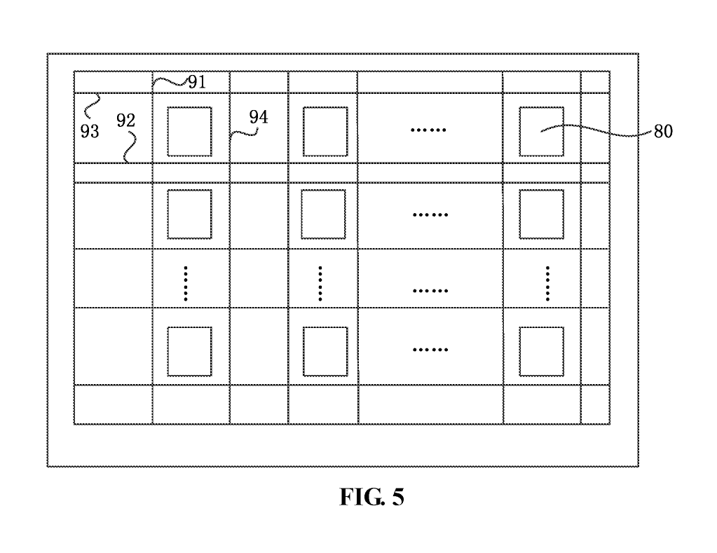

FIG. 4 is a drive timing diagram in which the display panel is driven with a second picture refresh frequency according to an embodiment of the disclosure, and FIG. 5 is a schematic diagram of a display panel according to an embodiment of the disclosure. Referring to FIG. 4 and FIG. 5, the display panel includes a plurality of data lines 91, a plurality of scan lines 92, a plurality of light-emitting control signal lines 93, a plurality of power signal lines 94 and a plurality of pixel units 80. The pixel unit 80 includes a pixel drive circuit and a light-emitting element, each data line 91 is configured for inputting a display data signal to a pixel unit 80 in the corresponding column, each scan line 92 is configured for inputting a scanning signal to a pixel unit 80 in the corresponding row, each light-emitting control signal line 93 is configured for inputting a pixel light-emitting control signal to a pixel unit 80 in the corresponding row, and the power signal line 94 is configured for inputting a first electrical level signal to a pixel unit 80 in the corresponding column. Under the control of the scanning signal and the pixel light-emitting control signal, the pixel drive circuit drives the light-emitting elements to emit light row by row so as to realize picture display. The drive timing of the pixel drive circuit will be illustrated below by an example in which the first row of light-emitting elements display one frame of the displayed picture.

In one embodiment, referring to FIG. 3 and FIG. 4, one frame of display picture further includes an initialization stage P1 and a data signal writing stage P2, and if the display panel is driven with a second picture refresh frequency to display the picture to be displayed, then:

in the initialization stage P1, the second scanning signal S2 is at a low level, the first scanning signal S1 and the pixel light-emitting control signal E1 are at a high level, and the electric potential on the control terminal of the drive module 10 and the electric potential on the first electrode of the light-emitting element 70 are reset to a low level;

in the data signal writing stage P2, the first scanning signal S1 is at a low level, the second scanning signal S2 and the pixel light-emitting control signal E1 are at a high level, and the electric potential on the control terminal of the drive module 10 is charged to the threshold voltage; and

in the light-emitting stage P3, the first scanning signal S1 and the second scanning signal S2 are at a high level, the pixel light-emitting control signal E1 is at a low level, and the light-emitting element 70 emits light.

In one embodiment, in the initialization stage P1, the fifth thin-film transistor M5 and the sixth thin-film transistor M6 are turned on, a reset signal Vref is written to a node N1 and a node N4 via the fifth thin-film transistor M5 and the sixth thin-film transistor M6, and hence the node N1 and the node N4 are reset to a low level.

In the data signal writing stage P2, the second thin-film transistor M2, the third thin-film transistor M3 and the fourth thin-film transistor M4 are turned on, a display data signal Vdata charges the node N1 via the second thin-film transistor M2, the third thin-film transistor M3 and the fourth thin-film transistor M4, and when the electric potential on the node N1 is a value equal to a threshold voltage Vdata-|Vth|, the third thin-film transistor M3 may be cut off, wherein Vth is the turn-on threshold voltage of the third thin-film transistor M3.

In the light-emitting stage P3, the first thin-film transistor M1, the third thin-film transistor M3 and the seventh thin-film transistor M7 are turned on, a light-emitting drive signal passes through the light-emitting element 70 and hence drives the light-emitting element 70 to emit light.

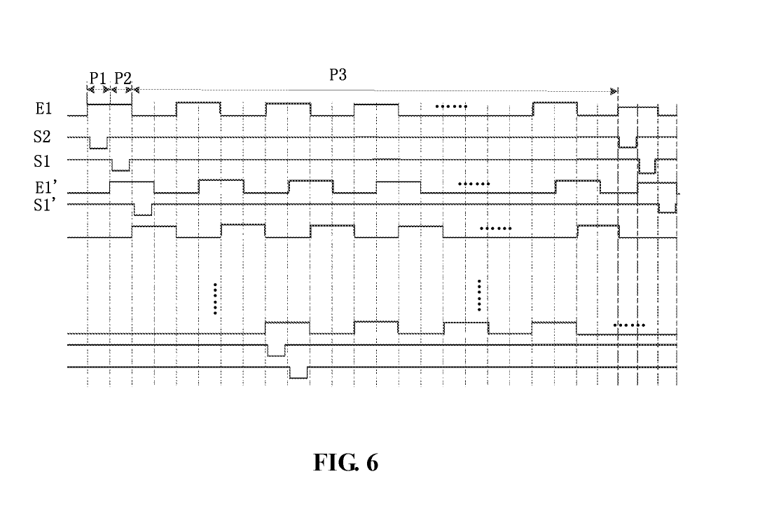

FIG. 6 is a drive timing diagram in which the display panel is driven with a first picture refresh frequency according to an embodiment of the disclosure. In one embodiment, referring to FIG. 3 and FIG. 6, one frame of display picture further includes an initialization stage P1 and a data signal writing stage P2, and if the display panel is driven with a first picture refresh frequency to display the picture to be displayed, then:

in the initialization stage P1, the second scanning signal S2 is at a low level, the first scanning signal S1 and the pixel light-emitting control signal E1 are at a high level, and the electric potential on the control terminal of the drive module 10 and the electric potential on the first electrode of the light-emitting element 70 are reset to a low level;

in the data signal writing stage P2, the first scanning signal S1 is at a low level, the second scanning signal S2 and the pixel light-emitting control signal E1 are at a high level, and hence the electric potential on the control terminal of the drive module 10 is charged to the threshold voltage; and

in the light-emitting stage P3, the first scanning signal S1 and the second scanning signal S2 are at a high level, the pixel light-emitting control signal E1 changes from a high level to a low level and includes n high level pulses, and the light-emitting stage P3 is divide into n+1 sub-light-emitting stages.

The implementations of the drive of the display panel with the first picture refresh frequency and with the second picture refresh frequency are the same at the initialization stage P1 and the data signal writing stage P2, and hence no repeated description may be given again here. In the light-emitting stage P3, when the pixel light-emitting control signal E1 is at a high level, the first thin-film transistor M1, the third thin-film transistor M3 and the seventh thin-film transistor M7 are turned off, the drive module 10 stops inputting the light-emitting drive signal to the light-emitting element 70, and the light-emitting element 70 is cut off. In this embodiment, the pixel light-emitting control signal E1 includes n high level pulses in the light-emitting stage P3, such that the light-emitting element 70 is turned off for n times, and in this case, one frame of display picture is interrupted for n times during display, this is equivalent to that the picture to be displayed is “refreshed” for n times visually, and the switch between pictures cannot be distinguished by human eyes, so that flicking can be avoided. Furthermore, because the first picture refresh frequency is low, the overall power consumption of the display panel can be lowered.

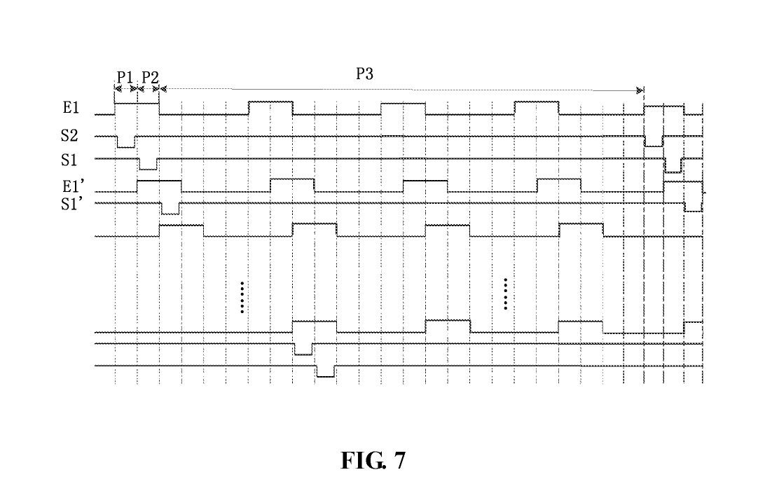

FIG. 7 is another drive timing diagram in which the display panel is driven with a first picture refresh frequency according to an embodiment of the disclosure. Referring to FIG. 7, in the light-emitting stage P3, the first scanning signal S1 and the second scanning signal S2 are at a high level, the pixel light-emitting control signal E1 changes from a high level to a low level and includes three high level pulses, and the light-emitting stage P3 is divide into four sub-light-emitting stages.

In one embodiment, the pixel light-emitting control signal E1 includes three high level pulses in the light-emitting stage P3, such that the light-emitting element is turned off for three times, and hence one frame of display picture is interrupted for three times during display, this is equivalent to that one frame of display picture is “refreshed” for 3 times visually. In such configuration, on one hand, the switch between pictures cannot be distinguished by human eyes, so that picture flicking can be avoided when the picture to be displayed is displayed with a low first picture refresh frequency; on the other hand, a low power consumption for the display panel can be guaranteed.

In one embodiment, if the display panel is driven with a first picture refresh frequency to display the picture to be displayed, the frequency of the display data signal Vdata may be equal to the first picture refresh frequency.

In one embodiment, because the first picture refresh frequency is small, the display panel does not need to read the display data signal Vdata at a high frequency. In this case, the frequency of the display data signal Vdata is equal to the first picture refresh frequency, such that the frequency of the display data signal Vdata may be lowered, thereby further lowering the power consumption of the display panel.

In one embodiment, the second picture refresh frequency is greater than or equal to 60 Hz; and the first picture refresh frequency is greater than or equal to 10 Hz.

In one embodiment, the second picture refresh frequency is greater than or equal to 60 Hz, such that the demand of the display panel on displaying a dynamic picture can be met while ensuring a not too high power consumption of the display panel. Because a thin-film transistor has a leakage current, the drive circuit cannot maintain the threshold voltage for a long time, and if the first picture refresh frequency is too low, because the change of the threshold voltage, the magnitude of the drive current of the organic light-emitting diode may be affected, so that the picture display quality of the display panel may be affected. By configuring that the first picture refresh frequency is greater than or equal to 10 Hz, it may be guaranteed that the display panel has a low power consumption, and the display panel has a high picture display quality.

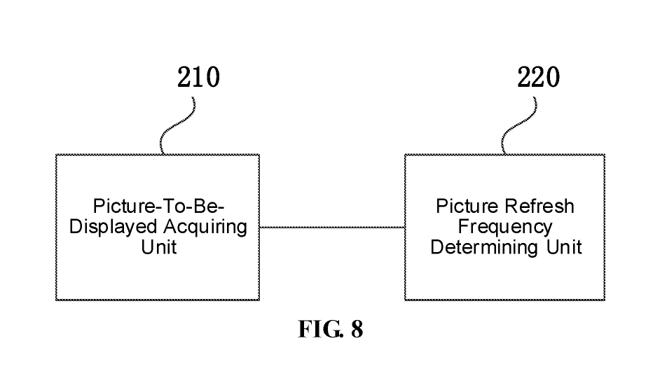

An embodiment of the disclosure further provides a drive device for a display panel. FIG. 8 is a schematic diagram of another drive device for a display panel according to an embodiment of the disclosure. Referring to FIG. 8, the drive device may includes:

a picture-to-be-displayed acquiring unit 210, configured for acquiring a picture to be displayed by a display panel;

a picture refresh frequency determining unit 220, configured for: driving the display panel with a first picture refresh frequency to display the picture to be displayed, if the number of successive frames of pictures same to the picture to be displayed exceeds a preset number of frames; otherwise, driving the display panel with a second picture refresh frequency to display the picture to be displayed;

wherein, the first picture refresh frequency is less than the second picture refresh frequency.

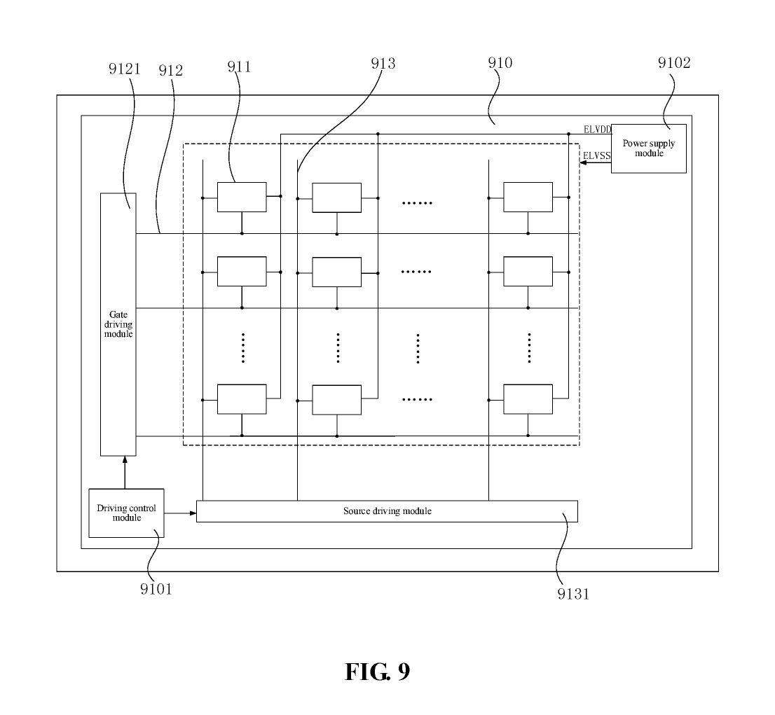

FIG. 9 is a structural representation of a display panel according to an embodiment of the disclosure. Referring to FIG. 9, the display panel includes a substrate 910 and a plurality of pixel circuits 911 located on the substrate 910. The display panel further includes a plurality of scan signal lines 912, a plurality of data signal lines 913, a gate driving module 9121, a source driving module 9131, a driving control module 9101 and a power supply module 9102. The pixel circuits 911 are disposed in spaces formed by crossing the scan signal lines 912 with the data signal lines 913. Responsive to a scan drive control signal generated by the driving control module 9101, the gate driving module 9121 inputs the scan signal to the corresponding pixel circuit 911 via the scan signal line 912. The pixel circuit 911 is enabled, based on the scan signal inputted via the scan signal line 912 electrically connected to the pixel circuit 911, to be connected to the corresponding data signal line 13 electrically connected to the pixel circuit 911. Responsive to a data drive control signal generated by the driving control module 9101, the source driving module 9131 inputs the data signal to the corresponding pixel circuit 911 via the data signal line 913. The power supply module 9102 provides the pixel circuit 911 with a first pixel power supply ELVDD and a second pixel power supply ELVSS, thereby achieving the display function of the display panel.

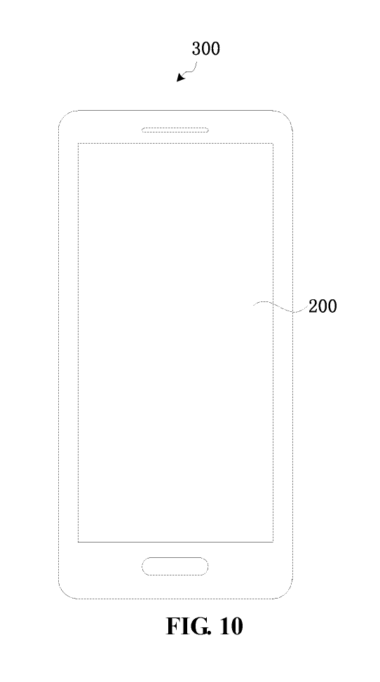

An embodiment of the disclosure further provides a display device. FIG. 10 is a structural representation of a display device according to an embodiment of the disclosure. Referring to FIG. 10, the display device 300 includes a display panel 200 according to any embodiment of the disclosure.

It should be noted that the embodiments of the present invention and the technical principles used therein are described as above. It should be appreciated that the invention is not limited to the embodiments described herein, and any apparent alterations, modification and substitutions can be made without departing from the scope of protection of the invention. Accordingly, while the invention is described in detail through the above embodiments, the invention is not limited to the above embodiments and can further include other additional embodiments without departing from the concept of the invention.

What is claimed is:

1. A drive method for a display panel, comprising:
acquiring a picture to be displayed by a display panel;
driving the display panel with a first picture refresh frequency to display the picture, if the number of successive frames of pictures that are the same as the picture exceeds a preset number of frames; otherwise, driving the display panel with a second picture refresh frequency to display the picture;
wherein, the first picture refresh frequency is less than the second picture refresh frequency.

2. The method as claimed in claim 1, wherein
the preset number of frames is greater than or equal to 10.

3. The method as claimed in claim 1, wherein
if one frame of the displayed picture comprises a light-emitting stage, then driving the display panel with the first picture refresh frequency to display the picture comprises:
in the light-emitting stage of one frame of display picture, a pixel light-emitting control signal controls a light-emitting element of the display panel to be turned off for n times to divide the light-emitting stage into n+1 sub-light-emitting stages, wherein n is a positive integer greater than or equal to 1.

4. The method as claimed in claim 3, wherein
the durations of the n+1 sub-light-emitting stages are equivalent.

5. The method as claimed in claim 4, wherein, n=3.

6. The method as claimed in claim 4, wherein
the display panel comprises a pixel drive circuit, which is configured for driving the light-emitting element of the display panel to emit light to display the picture;
the pixel drive circuit comprises a drive module, a first light-emitting control module, a second light-emitting control module, a data write module, a threshold voltage compensation module;
a control terminal of the first light-emitting control module is configured for receiving a pixel light-emitting control signal, a first terminal of the first light-emitting control module is configured for receiving a first electrical level signal, and a second terminal of the first light-emitting control module is electrically connected with a first terminal of the drive module;
a control terminal of the second light-emitting control module is configured for receiving the pixel light-emitting control signal, a first terminal of the second light-emitting control module is electrically connected with a second terminal of the drive module, and a second terminal of the second light-emitting control module is electrically connected with a first electrode of the light-emitting element;
a first terminal of the data write module is configured for receiving a display data signal, a second terminal of the data write module is electrically connected with the first terminal of the drive module, and a control terminal of the data write module is configured for receiving a first scanning signal;
a control terminal of the threshold voltage compensation module is configured for receiving the first scanning signal, a first terminal of the threshold voltage compensation module is electrically connected with the second terminal of the drive module, and a second terminal of the threshold voltage compensation module is electrically connected with a control terminal of the drive module; and
a first terminal of the storage module is configured for receiving the first electrical level signal, a second terminal of the storage module is electrically connected with the control terminal of the drive module, and the storage module is configured for maintaining the voltage on the control terminal of the drive module.

7. The method as claimed in claim 6, wherein
the pixel drive circuit further comprises an initialization module, wherein a control terminal of the initialization module is configured for receiving a second scanning signal, an input terminal of the initialization module is configured for receiving a reset signal, a first output terminal of the initialization module is electrically connected with the control terminal of the drive module, and a second output terminal of the initialization module is electrically connected with the first electrode of the light-emitting element.

8. The method as claimed in claim 7, wherein
one frame of display picture further comprises an initialization stage, a data signal writing stage and a light-emitting stage, and if the display panel is driven with the second picture refresh frequency to display the picture to be displayed, then:
in the initialization stage, an electric potential of the control terminal of the drive module and an electric potential of the first electrode of the light-emitting element are initialized;
in the data signal writing stage, data is written into the pixel drive circuit, and a threshold is captured from the drive module; and
in the light-emitting stage, the light-emitting element emits light.

9. The method as claimed in claim 7, wherein
one frame of display picture further comprises an initialization stage, a data signal writing stage and a light-emitting stage, and if the display panel is driven with the first picture refresh frequency to display the picture to be displayed, then:
in the initialization stage, an electric potential of the control terminal of the drive module and an electric potential of the first electrode of the light-emitting element are initialized;
in the data signal writing stage, data are written into the pixel drive circuit, and a threshold is captured from the drive module; and
in the light-emitting stage, the light-emitting stage is divided into n+1 sub-light-emitting stages.

10. The method as claimed in claim 6, wherein
if the display panel is driven with a first picture refresh frequency to display the picture to be displayed, the frequency of the display data signal is equal to the first picture refresh frequency.

11. The method as claimed in claim 1, wherein
the second picture refresh frequency is greater than or equal to 60 HZ, and the first picture refresh frequency is greater than or equal to 10 HZ.

12. A drive device for a display panel, comprising:
a picture-to-be-displayed acquiring unit, configured for acquiring a picture to be displayed by a display panel; and
a picture refresh frequency determining unit, configured for: driving the display panel with a first picture refresh frequency to display the picture to be displayed, if the number of successive frames of pictures that are the same as the picture to be displayed exceeds a preset number of frames; otherwise, driving the display panel with a second picture refresh frequency to display the picture to be displayed;
wherein, the first picture refresh frequency is less than the second picture refresh frequency.

13. A display panel, comprising a drive device for a display panel, wherein the drive device comprises:
a picture-to-be-displayed acquiring unit, configured for acquiring a picture to be displayed by a display panel; and
a picture refresh frequency determining unit, configured for: driving the display panel with a first picture refresh frequency to display the picture to be displayed, if the number of successive frames of pictures that are the same as the picture to be displayed exceeds a preset number of frames; otherwise, driving the display panel with a second picture refresh frequency to display the picture to be displayed;
wherein, the first picture refresh frequency is less than the second picture refresh frequency.

14. A display device, comprising the display panel comprising a drive device for a display panel, wherein the drive device comprises:
a picture-to-be-displayed acquiring unit, configured for acquiring a picture to be displayed by a display panel; and
a picture refresh frequency determining unit, configured for: driving the display panel with a first picture refresh frequency to display the picture to be displayed, if the number of successive frames of pictures that are the same as the picture to be displayed exceeds a preset number of frames; otherwise, driving the display panel with a second picture refresh frequency to display the picture to be displayed;
wherein, the first picture refresh frequency is less than the second picture refresh frequency.
